(19) United States
(12) Patent Application Publication
(10) Pub. No.: US 2025/0039994 A1
(43) Pub. Date: Jan. 30, 2025

(54) ALUMINUM BASED RESISTIVE HEATER

(71) Applicant: Heraeus Precious Metals North America Conshohocken LLC, WEST CONSHOHOCKEN, PA (US)

(72) Inventors: Gregory BERUBE, West Conshohocken, PA (US); Matthew SGRICCIA, West Conshohocken, PA (US); Dean BUZBY, West Conshohocken, PA (US)

(21) Appl. No.: 18/360,607

(22) Filed: Jul. 27, 2023

(51) Int. Cl. H05B 3/16; H05B 3/08; H05B 3/26

(52) U.S. Cl. CPC H05B 3/16; H05B 3/08; H05B 3/262; H05B 2203/01; H05B 2203/017

(57) ABSTRACT

The invention relates to an aluminum resistive heater containing, a heat conductive substrate comprising an electrically insulating surface. An aluminum resistive structure is provided on the electrically insulating surface, wherein the aluminum resistive structure comprises, at least one aluminum conductive layer covering at least a part of the electrically insulating surface, wherein the aluminum conductive layer comprises aluminum and at least a first glass. The aluminum resistive structure further comprises at least two terminal contact pads contacting the aluminum conductive layer, wherein the terminal contact pads comprise silver. An overglaze comprising glass covers at least a part of the aluminum resistive structure. Furthermore the invention relates to a method for making the aluminum resistive heater.

The present invention is directed to an improved aluminum based resistive heater which is easy to produce and a method for producing such aluminum based resistive heater.

### INTRODUCTION

Typically, thick film heaters are based on silver, ruthenium, palladium, or some combination of these conductive materials. The advantage of those heaters is that these materials are easy to handle during production and exhibit good corrosion resistance of the resulting structures. On the other hand, due to high and fluctuating precious metal prices, it is desirable to replace silver and palladium with cheaper materials with comparable conductivity.

For this purpose, aluminum based resistive heaters have been developed because aluminum is known to be highly suitable as a conductor and due its self-passivating properties it is also corrosion resistant. Aluminum based resistive heaters are for example know from U.S. Pat. No. 6,531,181B1 The heaters of the prior art are produced via thick film technology by printing an aluminum thick film paste. Aluminum thick film pastes contain aluminum powder, glass frit and a vehicle. Those thick film pastes can be applied in any desired layout. Typically, heater structures are printed via thick film screen printing. The printed thick film structures are subsequently fired.

To ensure proper heat distribution throughout the device, the resistive heater can be applied directly to a ceramic substrate (i.e. alumina) which acts as an insulative layer or to a metal substrate (aluminum or steel) covered with a dielectric insulative layer. The dielectric layer may be produced via thick film coating, e.g. a ceramic thick film paste, and subsequent firing of the ceramic paste to obtain a dielectric surface on which a resistive heater structure can be applied without any shorts.

One problem arising during production of aluminum thick film heaters is that aluminum, and aluminum thick film pastes in particular, are prone to balling when fired at temperatures above the melting point of aluminum which deteriorates film formation. Nevertheless, high firing temperatures for the aluminum thick film paste are desirable to ensure good adhesion, stable resistance, and because such high temperature pastes can be processed under the same firing conditions and in the same firing ovens, e.g. conveyor belt ovens, as the dielectric material located underneath the resistive heater.

Another problem of aluminum resistive heaters is that they are more difficult to contact because aluminum cannot be soldered directly. The aluminum resistive heater structure of U.S. Pat. No. 6,531,181B1 can for example be contacted by clamping.

It was an object of the present invention to overcome at least one of the problems of the prior art.

In particular it was an objective to provide an aluminum resistive heater which is easy and fast to produce and easy to handle.

It was another objective of the invention to provide a method which provides aluminum resistive heaters with comparable performance to silver based heaters.

In particular it was another objective to provide an aluminum resistive heater which has a high thermal stability.

In particular it was an object to provide an aluminum resistive heater which does not contain precious metals.

It was another objective of the invention to reduce balling of aluminum during the production of the aluminum conductive structure. Less balling may lead to less defects in the aluminum conductive structure.

At least one of the above problems indicated in the prior art is solved by the subject matter of the independent claims.

In a first aspect the invention relates to an aluminum resistive heater containing,
a. a heat conductive substrate comprising an electrically insulating surface,
b. an aluminum resistive structure provided on the electrically insulating surface, wherein the aluminum resistive structure comprises,
   i. at least one aluminum conductive layer covering at least a part of the electrically insulating surface, wherein the aluminum conductive layer comprises aluminum and at least a first glass,
   ii. at least two terminal contact pads contacting the aluminum conductive layer, wherein the terminal contact pads comprise silver.
c. an overglaze comprising glass, the overglaze covering at least a part of the aluminum resistive structure.

A resistive heater may be understood as a conductive structure which generates heat when an electrical current flows through the structure. In the context of the invention resistive heaters are preferably provided as conductive layers on an electrically insulating substrate.

The aluminum resistive heater comprises an electrically conductive substrate comprising an electrically insulating surface. Preferably the conductive substrate is a metal sheet, a metal foil or a metal body. Metals may comprise elemental metals and metal alloys. Elemental metals are preferably selected from the group consisting of aluminum, copper, steel. The advantage of metal substrates is that metal exhibits good heat conductivity and thus provides good heat transfer to the object to be heated.

Alternative heat conductive substrates comprise ceramics, like e.g., oxide or nitride ceramics.

The heat conductive substrate comprises an electrically insulating surface. Preferably the electrically insulating surface contains or consists of aluminum oxide.

In the case of heat conductive substrate materials which are inherently electrically insulating, e.g. oxide or nitride ceramic materials, the surface of those substrates is also electrically insulating. Therefore, it is optional that such heat conductive structures do not comprise any additionally added layers.

On the other hand, if the heat conductive substrate material comprises metal, the heat conductive substrate preferably comprises a dielectric layer which exhibits an electrically insulating surface. The dielectric layer may comprise a material selected from the group consisting of ceramics, glass, or mixtures thereof. The ceramics may comprise a material selected from the group consisting of oxide ceramics, nitride ceramics and carbide ceramics. Oxide ceramics may for example include aluminum oxide, silicon oxide, titanium oxide. Nitride ceramics may for example include silicon nitride or titanium nitride. Carbide ceramics may for example include silicon carbide.

The dielectric layer preferably is applied by a method selected from thick film coating or thin film coating. Thick film coating comprise printing, e.g. screen printing or blade coating. Thin film coating comprises methods like e.g. sputtering, plasma coating, CVD and PVD. It is particularly preferred that the dielectric layer is prepared by screen printing.

The aluminum resistive heater further comprises aluminum resistive structure provided on the electrically insulating surface. The aluminum resistive structure can irradiate heat if sufficient electrically current flows through it.

The aluminum resistive structure comprises at least one aluminum conductive layer covering at least a part of the electrically insulating surface, wherein the aluminum conductive layer comprises aluminum and at least a first glass.

The aluminum conductive layer may have any layout the skilled person for resistive heaters may consider to be useful for the desired application. Preferably the aluminum conductive layer exhibits a meandering portion. Optionally the aluminum conductive layer may contain a trimming section. The trimmings section may comprise a structure which allows to adjust the resistance of the aluminum conductive layer.

The aluminum conductive layer preferably comprises at least 40 wt.-%, in particular at least 50 wt.-% aluminum based on the total weight of the aluminum conductive layer. The aluminum conductive layer preferably comprises at most 90 wt.-%, in particular at most 80 wt.-% aluminum based on the total weight of the aluminum conductive layer. Optionally the at least one aluminum conductive layer further comprises copper. Preferably the at least one aluminum conductive layer comprises at least 2 wt.-%, more preferably at least 3.5 wt.-% of copper. At the same the at least one aluminum conductive layer optionally comprises at most 10 wt.-%, preferably at most 8 wt. % of copper, based on the total weight of the at least one aluminum conductive layer. Preferably the aluminum conductive layer does not contain any additional metals except aluminum and copper in an amount of more than 0.5 wt. %, in particular of more than 0.1 wt. %. Optionally the aluminum conductive layer does not contain any intentionally added metals other than aluminum or copper.

The at least one aluminum conductive layer preferably comprises at least 5 wt.-%, preferably at least 10 wt.-% of glass. Optionally the aluminum conductive layer comprises at most 25 wt.-% of glass. Weight percentages are calculated based on the total weight of the at least on aluminum conductive layer. The glass comprises a first glass and optionally a second glass.

The first glass of the aluminum conductive layer preferably has a glass transition temperature in the range from 400° C. to 500° C. A glass with a glass transition temperature in this range may reduce balling of aluminum during firing of the aluminum containing thick film paste, even when fired at temperatures above 750° C. The glass transition temperature in the context of the invention can be measured according to ASTM E1356-03 (version valid at the date of filing). The first glass of the aluminum conductive layer preferably has a softening point in the range from 470° C. to 550° C. The softening point in the context of the invention can be measured according to ASTM C338-93 (2019).

In a preferred embodiment the at least one aluminum conductive layer comprises two or more glasses. In particular the at least one aluminum conductive layer may comprise two glasses exhibiting different glass transition temperatures, softening temperatures or melting temperatures. The at least one conductive layer preferably comprises at least a second glass exhibiting a glass transition temperature in the range from 600° C. to 650° C.

At least one of the first glass and the second glass or both can be selected from the group of borosilicate glasses, preferably lead-free borosilicate glasses. Preferably the first glass and the second glass are selected from the group of borosilicate glasses, for example alumino borosilicate glasses.

The first glass, in particular a borosilicate glass, preferably comprises at least one component selected from the group consisting of vanadium oxide, lithium oxide, potassium oxide, sodium oxide, zinc oxide, calcium oxide, barium oxide, magnesium oxide, titanium oxide, zirconium oxide, and bismuth oxide. Optionally other components may be added to the glass to adjust the glass properties in a desired way. In one preferred embodiment the first glass is a borosilicate glass containing 7-15 wt.-alkali metal oxides, like e.g. lithium oxide, sodium oxide and potassium oxide. Further the first glass optionally may contain 20 wt.-% to 35 wt.-% bismuth. Weight percentages are calculated from the total weight of the first glass.

The second glass, in particular a borosilicate glass, preferably comprises at least one component selected from the group consisting of zinc oxide, calcium oxide, titanium oxide, zirconium oxide, barium oxide magnesium oxide and molybdenum oxide. In one example the second glass comprises 1 wt.-% to 15 wt.-% alumina and 10 wt.-% to 30 wt.-% zinc oxide. Weight percentages are calculated from the total weight of the second glass.

Optionally the aluminum resistive structure comprises two or more aluminum conductive layers. In this case the given amounts for the components above preferably also apply to those further aluminum conductive layers. Preferably the first and any further conductive layer may be present as multiple traces next to each other on the same surface. Optionally the first and any further aluminum conductive layer are contact by the same terminal contact pads.

The sheet resistance of the aluminum conductive layer preferable is in the range from 25 milliohm/square to 500 milliohm/square.

The aluminum resistive structure further comprises at least two terminal contact pads contacting the conductive layer. Terminal contact pads in the context of the invention preferably means that those contact pads are located at opposite ends of the aluminum conductive layer so that electrical current may be injected via one contact pad, flows through the at least one aluminum conductive layer and is subsequently extracted at a second contact pad. Optionally the aluminum resistive structure can contain multiple terminal contact pads.

The contact pads may improve the contactability of the at least one conductive layer. Preferably the contact pads allow to contact the aluminum containing conductive layer via soldering or brazing. The terminal contact pads can advantageously be used to facilitate connection and protect the aluminum conductive layer from mechanical damage during contacting. The terminal contact pads preferably comprise silver, in particular sintered silver particles. Optionally the terminal contact pads contain at least one further metal. In particular the further metal may be selected from palladium and platinum. In the case where at least one further metal is contained in the terminal contact pads the silver and the at least one further metal can be present as a mixture or as an alloy. Optionally, the terminal contact pads consist of silver, a silver mixture or a silver alloy. In the mixture or the alloy silver and the at least one further metal may be present in a weight ratio of 9:1 to 25:1.

The aluminum resistive heater further contains an overglaze comprising or consisting of glass. The overglaze covers at least a part of the aluminum resistive structure. Preferably the overglaze fully covers the aluminum resistive structure except for at least a part of the terminal contact pads to ensure electrical connection of the aluminum resistive heater, e.g. by wires. The overglaze can protect the aluminum resistive structure from mechanical damage, chemical corrosion, and electrical shorts. The glass of the overglaze preferably has a glass transition temperature in the range from 400° C. to 500° C., preferably in the range from 450° C. to 480° C. Also preferred the glass of the overglaze has a softening point in the range of 500° C. to 570° C.

In one embodiment the overglaze contains a glass selected from the group of bismuth—borosilicate glasses. Optionally, the bismuth-borosilicate glass may contain at least one element selected from the group consisting of zinc, aluminum, and titanium or combinations thereof. Preferable, the total concentration of bismuth, boron, and silicon contained in the glass as oxides is at least 80 wt %, in particular at least 85%. Optionally the amount of silicon oxide is in in the range from 25 wt.-% to 60 wt.-%.

In a second aspect the invention relates to a method for preparing an aluminum resistive heater comprising the steps:
a) applying at least one layer of dielectric paste on a heat conductive substrate,
b) firing the at least one layer of dielectric paste at a first firing temperature to obtain a heat conductive substrate containing an electrically insulating surface,
c) applying a layer of an aluminum thick film paste on the electrically insulating surface, wherein the thick film paste comprises aluminum, at least a first glass and a vehicle,
d) firing the layer of the aluminum thick film paste at a second firing temperature to obtain an aluminum conductive layer,
e) applying a thick film conductor paste comprising silver on the aluminum conductive layer to obtain at least two terminal contact pads,
f) firing the terminal contact pads at a third firing temperature to obtain an aluminum resistive structure,
g) applying an overglaze paste over at least the aluminum resistive structure, and
h) firing the overglaze paste at a fourth firing temperature to obtain an aluminum resistive heater.

Preferably the method of the invention can be used to prepare the aluminum resistive heater according to the first aspect of the invention.

In step a) at least one layer of dielectric paste is applied on a conductive substrate. The conductive substrate is heat conductive and optionally may be electrically conductive, e.g. metallic foil or sheet. Preferably the conductive substrate is a metal sheet.

Preferably the dielectric paste comprises a ceramic or glass as a dielectric. The dielectric is preferably provided as a powder which consists of particles having a particle size distribution. The dielectric paste preferably comprises at least a ceramic powder, e.g. alumina powder, a glass powder or a mixture thereof.

The dielectric paste further comprises at least one vehicle. The vehicle may be an organic or an inorganic vehicle. In particular the vehicle contains at least one solvent. Preferably the vehicle is an organic vehicle. Solvents may be selected for example from the group consisting of terpene alcohols, e.g. alpha terpineol, terpene hydrocarbons, glycols and diglycols, glycol ethers and glycol esters. Optionally the dielectric paste may comprise additional components like e.g rheology modifiers, stabilizers, dispersants, surfactants etc. The dielectric paste is preferably applied by printing, in particular by screen printing or blade coating. After application the paste may optionally be dried.

It is preferred that the dielectric paste completely covers the surface of the conductive substrate on which at least one aluminum resistive structure shall be applied. Alternatively, the dielectric layer may only be applied on regions of the conductive substrate to prevent direct electrical contact between the conductive substrate and the aluminum resistive structure.

In a preferred embodiment more than one layer of dielectric paste is applied to the surface of the conductive substrate, in particular three or more layers of dielectric paste are applied. In cases where more than one layer of dielectric paste is applied optionally at least one layer of dielectric paste is dried after application to the electrically conductive substrate. In one embodiment each layer of dielectric paste is dried after its application.

In the next step the at least one layer of dielectric paste is fired at a first firing temperature to obtain a conductive substrate containing an electrically insulating surface. The firing partly or fully removes the vehicle and preferably sinters the dielectric particles in the paste. The dielectric layer generated by firing the dielectric paste has an electrically insulating surface.

The first firing temperature preferably is in the range from 750° C. to 900° C., preferably in the range from 800° C. to 900° C. Firing in the context of the invention is preferably done in an oven, like e.g. a conveyor belt oven or a batch oven. The temperatures given in this disclosure are preferably measured at the substrate.

Preferably each layer of dielectric paste is dried and subsequently fired after application Alternatively drying is carried out after each application step and firing is carried out after the last drying step only.

Preferably the layer thickness of the obtained individual dielectric layer after firing is in the range from 15 μm to 35 μm. In a preferred embodiment the insulation resistance of the dielectric layer is at least 1 Gohm at 100 V, as measured with an Omnia II Series Electric

### Analyzer.

In the following step a layer of an aluminum thick film paste is applied on the electrically insulating surface, wherein the aluminum thick film paste comprises aluminum, at least a first glass and a vehicle. Preferably the thick film paste is applied by screen printing, blade coating or stencil printing.

Preferably the aluminum and the at least one first glass are contained in the thick film paste as powders. It is preferred that the aluminum powder has a mean particle size d₅₀ in the range from 1-5 μm. The glass powder preferably has a mean particle size d₅₀ in the range from 2 to 5 μm.

The vehicle is preferably contained in the aluminum thick film paste in an amount of 15 wt.-% to 30 wt.-%.

The aluminum thick film paste preferably comprises at least 40 wt.-%, in particular at least 50 wt.-% aluminum based on the total weight of the aluminum thick film paste. Further the aluminum thick film paste may comprise 80 wt.-% of aluminum at most, preferably 70 wt.-% at most.

Optionally the aluminum thick film paste further comprises copper. The copper in the paste may reduce the tendency of aluminum balling during firing. The copper in the thick film paste can be present as particles, separate from the aluminum, as a part of the aluminum particles, e.g. as a coating, or in the form of an aluminum-copper alloy particles. Preferably the aluminum thick film paste comprises at least 1 wt.-%, more preferably at least 2.5 wt.-% of copper. At the same the aluminum thick film paste optionally comprises at most 7 wt.-%, preferably at most 5 wt. % of copper, based on the total weight of the aluminum thick film paste. Preferably the aluminum thick film paste does not contain any metals except aluminum and copper in an amount of more than 0.5 wt. %, in particular of more than 0.1 wt. %. Optionally the aluminum thick film paste does not contain any intentionally added metals other than aluminum or copper.

The aluminum thick film paste preferably comprises at least 5 wt.-%, preferably at least 10 wt.-% of glass. Optionally the aluminum thick film paste comprises at most 35 wt.-% of glass. Weight percentages are calculated based on the total weight of the at least on aluminum thick film paste.

The first glass of the aluminum thick film paste preferably has a glass transition temperature in the range from 400° C. to 500° C. A glass with a glass transition temperature in this range may reduce balling of aluminum during firing of the aluminum containing thick film paste, even when fired at temperatures above 750° C. The glass transition temperature in the context of the invention can be measured according to ASTM E1356-03 (version valid at the date of filing). The first glass of the aluminum thick film paste preferably has a softening point in the range from 470° C. to 550° C. The softening point in the context of the invention can be measured according to ASTM C338-93 (2019).

In a preferred embodiment the at least one aluminum thick film paste comprises two or more glasses. In particular the at least one aluminum thick film paste may comprise two glasses exhibiting different glass transition temperatures, softening temperatures or melting temperatures. The aluminum thick film paste preferably comprises at least a second glass exhibiting a glass transition temperature in the range from 600° C. to 650° C. This can be useful to adjust the electrical properties of the aluminum conductive layer.

At least one of the first glass and the second glass or both can be selected from the group of borosilicate glasses, preferably lead-free borosilicate glasses. Preferably the first glass and any further glasses are selected from the group of borosilicate glasses.

The first glass, in particular a borosilicate glass, preferably comprises at least one component selected from the group consisting of vanadium oxide, lithium oxide, potassium oxide, sodium oxide, zinc oxide, calcium oxide, barium oxide, magnesium oxide, titanium oxide, zirconium oxide, and bismuth oxide. Optionally other components may be added to the glass to adjust the glass properties in a desired way. In one preferred embodiment the first glass is a borosilicate glass containing 7 to 15 wt.-% alkali metal oxides, like e.g. lithium oxide, sodium oxide and potassium oxide. Further the first glass optionally may contain 20 wt.-% to 35 wt.-% bismuth.

The second glass, in particular a borosilicate glass, preferably comprises at least one component selected from the group consisting of zinc oxide, calcium oxide, aluminum oxide, titanium oxide, zirconium oxide, barium oxide magnesium oxide and molybdenum oxide. In one example the second glass comprises 1-15 wt.-% alumina and optionally 10-30 wt.-% zinc oxide.

In the subsequent step the layer of aluminum thick film paste is fired at a second firing temperature to obtain an aluminum conductive layer. The second firing temperature preferably is in the range from 750° C. to 900° C., preferably in the range from 800° C. to 900° C. Preferably the vehicle is an organic vehicle which can be removed by firing at the second temperature.

Firing the aluminum thick film paste at temperatures of at least 150° C. higher than the melting temperature of aluminum has the advantage that better adhesion to the underlying substrate may be achieved.

In a preferred embodiment the first firing temperature and the second firing temperature differ by at most 50° C., preferably by at most 20° C. In a particularly preferred embodiment, the first and the second firing temperatures are the same. This has the advantage, that the first and the second firing step can be done with the same oven settings. If the temperature is not changed between the first and second firing, the oven does not need to be equilibrated at a new temperature which reduces the overall process time.

The aluminum conductive layer after firing preferably has a sheet resistance in the range from 25 milliohm/square to 500 milliohm/square, when using a standard four probe measurement.

The layer thickness of the fired aluminum conductive layer can optionally be in the range from 20 μm-50 μm, preferably in the range from 30 μm-40 μm.

The fired aluminum conductive layer preferably has a roughness (Ra) in the range from 0.5 μm to 3 μm, preferably in the range from 1.0 μm to 1.5 μm as measured with an optical profilometer Cyberscan Vantage 2 with the software Scan Suite from Cybertechnologies according to ISO 25178-2:2021 in connection with ISO 25178-602:2010.

In the following step a thick film conductor paste is applied on the aluminum conductive layer to obtain at least two terminal contact pads. The application of the terminal contact pads is preferably done by screen printing a thick film conductor paste. The thick film conductor paste preferably contains a metal and an organic vehicle. Preferably the amount of metal is at least 70 wt.-% based on the weight of the paste. The metal can for example contain or consist of silver or a silver alloy. In particularly preferred embodiments the thick film conductor paste is a silver thick film paste, optionally a glass free silver thick film paste. The thick film conductor paste preferably is a silver sinter paste. Preferably the terminal contact pads overlap at least partially or fully with the aluminum conductive layer.

In the next step the terminal contact pads are fired at a third firing temperature to obtain an aluminum resistive structure. Preferably the third firing temperature is in the range from 500° C. to 600° C. In this temperature range the particles of the thick film conductor paste for the contact pads preferably sinter together. Sintering typically involves surface diffusion mechanisms. It should be taken that the firing temperature is below the melting temperature of aluminum during the whole process in order not to deteriorate the aluminum conductive layer. A terminal contact pad prepared from a silver sinter paste when sintered below the aluminum melting temperature advantageously has very good adhesion to the aluminum conductive layer and at the same time provides excellent conductivity and mechanical protection.

The aluminum resistive structure preferably has a temperature coefficient of resistance in the range from 2000 to 3000 ppm/K.

After the firing step at the third temperature an overglaze paste is applied at least over the aluminum resistive structure. The overglaze paste comprises a glass powder and a vehicle. Preferably the vehicle is an organic vehicle. Optionally the overglaze paste may comprise additional components. For example, the overglaze paste may contain components which facilitate printing or improve storage time.

Preferably the overglaze is printed, in particular by screen printing or blade coating. Optionally the overglaze covers the complete aluminum conductive layer and the underlying electrically insulating surface. It is particularly preferred that the terminal contact pads are at least partly not covered by the overglaze paste.

The overglaze paste is fired at a fourth firing temperature to obtain an aluminum resistive heater. Preferably the fourth firing temperature is in the range from 500° C. to 600° C.

In a preferred embodiment the third firing temperature and the fourth firing temperature differ by at most 50° C., preferably by at most 20° C. This has the advantage, that the third and the fourth firing step can be done with the same oven settings. If the temperature is not changed between the third and fourth firing steps, the oven does not need to be equilibrated at a new temperature which reduces the overall process time.

The layer thickness of the overglaze after firing preferably is in the range from 5 μm to 20 μm.

The aluminum resistive heater obtained by the process according to the invention preferably exhibits the same or similar performance as a silver based resistive heater.

### Example

A stainless-steel foil of 1 cm×1 cm was provided as a conductive substrate. Three layers of an alumina thick film paste (SD 1010A, from Heraeus GmbH, Germany) were subsequently applied to the surface of the conductive substrate by screen printing (280-325 mesh stainless steel screen) and each layer was dried for 10 minutes and individually fired at a first temperature of 850° C. to obtain an electrically insulating surface on the electrically conductive substrate. In the next step an aluminum thick film paste comprising a glass was printed in a meandering structure on the electrically insulating surface previously prepared. The glass was a borosilicate glass comprising 25 wt.-% bismuth oxide and 13 wt.-% in sum of lithium, sodium and potassium oxide wherein the glass has a glass transition temperature of about 480° C. and a softening temperature of about 560° C. The aluminum powder had a mean particle size d₅₀ of about 1 μm and the glass had a particle size d₅₀ of about 2 μm. The printed aluminum thick film past was dried for about 10 minutes and subsequently fired at a second temperature of 850° C. for about 10 minutes to form an aluminum conductive structure. The fired film thickness was about 40 μm.

Subsequently, a lead-free silver conductor paste (commercially available as C8829D from Heraeus Deutschland Gmbh & Co. KG, Germany) was used to screen print two terminal contact pads at each terminal end of the meandering structure of the aluminum conductive structure. The contact pads were fired at a third temperature of 550° C. to a fired film thickness of 15 μm to obtain an aluminum resistive structure. Finally, a Pb, Cd and Ni free overglaze (IP9038A from Heraeus Deutschland Gmbh & Co. KG, Germany) was screen printed on the surface of the substrate except for the openings at the locations of the terminal contact pads. The over glaze was dried for 10 minutes and fired at a fourth temperature of 550° C. for 10 minutes to obtain a fired film thickness of 15 μm. Firing was done in a conveyor belt oven. Due the fact that the first and the second firing temperatures were the same and the third and the fourth firing temperatures were the same, the process was very quick, since only one change of temperature had to be done in the oven.

### LIST OF REFERENCES NUMBERS

110 Heat conductive substrate
120 Dielectric layer
130 overglaze
140 Terminal contact pads
150 Aluminum conductive layer
210 Heat conductive substrate
220 Dielectric layer
230 Overglaze
240 Terminal contact pads
250 Aluminum conductive layer

### DESCRIPTION OF FIGURES

In the following the invention will be illustrated by figures showing preferred embodiments.

FIG. 1 shows a cross section of the aluminum resistive heater according to the invention.

FIG. 2 shows a top view of the same aluminum resistive heater as depicted in FIG. 1.

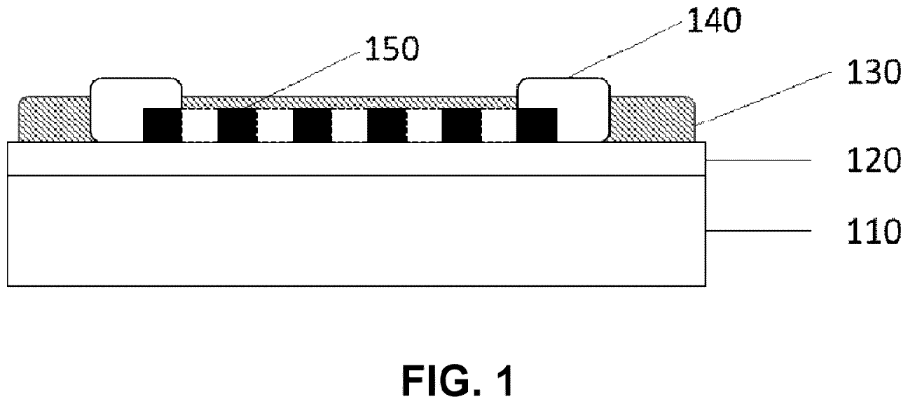

FIG. 1 shows an aluminum resistive heater containing a heat conductive substrate (110). The heat conductive substrate preferably is a metal substrate but alternatively the material may comprise or consist of a ceramic. On the surface of the heat conductive substrate (110) a dielectric layer (120) is arranged. The dielectric layer (120) has an electrically insulating surface. On the electrically insulating surface of the substrate which is generated by the dielectric layer (120) an aluminum conductive layer (150) is arranged. Preferably the aluminum conductive layer (150) has a meandering section. At the terminal ends of the aluminum conductive layer (150) terminal contact pads (140) are arranged. The aluminum conductive layer (150) and the terminal contact pads (140) form an electrical contact. The aluminum conductive layer (150) and the electrically insulating surface of the heat conductive substrate (110/120) are at least partially covered by the overglaze (130). The overglaze preferably contains or consists of glass.

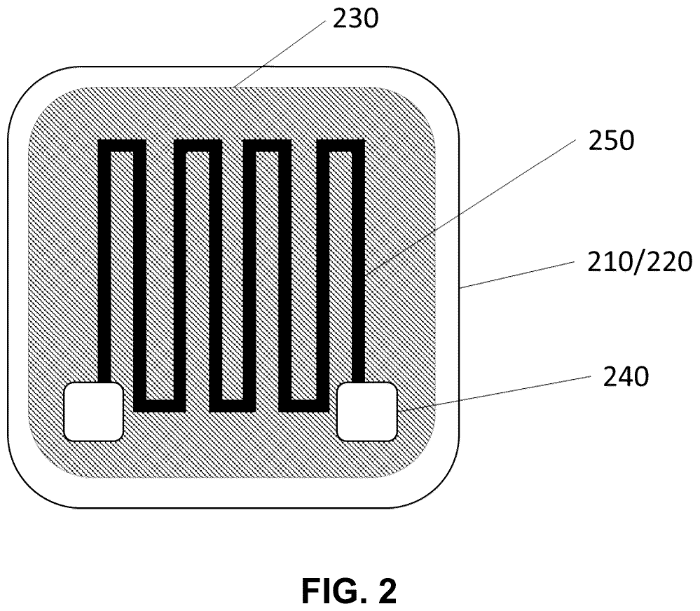

FIG. 2 shows a top view of the same aluminum resistive heater as depicted in FIG. 1. The heat conductive substrate (210) contains a dielectric layer (220). Since the dielectric covers the heat conductive substrate the reference numbers are used together (210/220) in this top view perspective. On the electrically insulating surface an aluminum conductive layer (250) is formed. The aluminum conductive layer can have a meandering structure. At the terminal ends of the aluminum resistive layer (250) terminal contact pads (240) are arranged. The electrically insulating surface of the heat conductive substrate (210) and the aluminum conductive layer are covered by an overglaze (230).

1. An aluminum resistive heater containing:
a. a heat conductive substrate comprising an electrically insulating surface,
b. an aluminum resistive structure provided on the electrically insulating surface, wherein the aluminum resistive structure comprises:
i. at least one aluminum conductive layer covering at least a part of the electrically insulating surface, wherein the aluminum conductive layer comprises aluminum and at least a first glass, and
ii. at least two terminal contact pads contacting the aluminum conductive layer, wherein the terminal contact pads comprise silver, and
c. an overglaze comprising glass, the overglaze covering at least a part of the aluminum resistive structure.

2. The aluminum resistive heater of claim 1, wherein the at least one aluminum conductive layer further contains copper.

3. The aluminum resistive heater according the of claim 1, wherein the terminal contact pads contain sintered metal particles.

4. The aluminum resistive heater of claim 1, wherein the conductive substrate contains at least one metal selected from the group consisting of steel, copper, aluminum, and stainless steel.

5. The aluminum resistive heater of claim 1, wherein the electrically insulating surface contains aluminum oxide.

6. A method for preparing an aluminum resistive heater comprising the steps:
a) applying at least one layer of dielectric paste on a heat conductive substrate,
b) firing the at least one layer of dielectric paste at a first firing temperature to obtain a heat conductive substrate containing an electrically insulating surface,
c) applying a layer of an aluminum thick film paste on the electrically insulating surface, wherein the thick film paste comprises aluminum, at least a first glass and a vehicle,
d) firing the layer of the aluminum thick film paste at a second firing temperature to obtain an aluminum conductive layer,
e) applying a thick film conductor paste comprising silver on the aluminum conductive layer to obtain at least two terminal contact pads,
f) firing the terminal contact pads at a third firing temperature to obtain an aluminum resistive structure,
g) applying an overglaze paste over at least the aluminum resistive structure, and
h) firing the overglaze paste at a fourth firing temperature to obtain an aluminum resistive heater.

7. The method of claim 6, wherein the first glass of the aluminum thick film paste has a glass transition temperature in the range from 400° C. to 500° C.

8. The method according the of claim 6, wherein the aluminum thick film paste comprises at least a second glass exhibiting a glass transition temperature in the range from 600° C. to 650° C.

9. The method of claim 6, wherein at least one of the first glass and the second glass are selected from the group of borosilicate glasses, preferably lead free borosilicate glasses.

10. The method according the of claim 6, wherein the first glass comprises at least one component selected from the group consisting of vanadium oxide, lithium oxide, potassium oxide, sodium oxide, zinc oxide, calcium oxide, barium oxide, magnesium oxide, titanium oxide, zirconium oxide, and bismuth oxide.

11. The method according the of claim 8, wherein the second glass comprises at least one component selected from the group consisting of zinc oxide, aluminum oxide, calcium oxide, titanium oxide, zirconium oxide, barium oxide magnesium oxide and molybdenum oxide.

12. The method of claim 6, wherein the first firing temperature is in the range from 800° C. to 900° C. or the second firing temperature is in the range from 800° C. to 900° C. or both.

13. The method of claim 6, wherein the first firing temperature and the second firing temperature differ by at most 50° C., preferably by at most 20° C.

14. The method according the of claim 6, wherein the third firing temperature is in the range from 500° C. to 600° C. or the fourth firing temperature is in the range from 500° C. to 600° C. or both.

15. The method according the of claim 6, wherein the third firing temperature and the fourth firing temperature differ by at most 50° C.

16. The method of claim 8, wherein at least one of the first glass and the second glass are selected from the group of borosilicate glasses.

17. The method of claim 9, wherein the borosilicate glasses are lead free borosilicate glasses.

18. The method of claim 6, wherein the first firing temperature and the second firing temperature differ by at most 20° C.

19. The method of claim 6, wherein the third firing temperature and the fourth firing temperature differ by at most 20° C.
